(19) United States
(12) Patent Application Publication
(10) Pub. No.: US 2014/0169536 A1
(43) Pub. Date: Jun. 19, 2014

(54) Integration of telephone audio into electronic meeting archives

(71) Applicants: Nigel Pegg, Berkeley, CA (US); Srinivas Manapragada, Fremont, CA (US); Bhanu Sharma, San Bruno, CA (US)

(72) Inventors: Nigel Pegg, Berkeley, CA (US); Srinivas Manapragada, Fremont, CA (US); Bhanu Sharma, San Bruno, CA (US)

(73) Assignee: Macromedia, Inc., San Francisco, CA (US)

(21) Appl. No.: 11/110,651

(22) Filed: Apr. 20, 2005

(51) Int. Cl. H04M 3/42; H04M 3/56

(52) U.S. Cl. CPC H04M 3/42221; H04M 3/568
USPC 379/87

(57) ABSTRACT

A system and method for integrating telephone audio into an electronic meeting archive is described. A plurality of telephony signaling messages are received and converted into an electronic meeting application format. The meeting or conferencing system generates metadata from any one or more of the telephony signaling messages, electronic information presented during an electronic meeting, or the like, where the metadata is associated with a particular meeting event time. The metadata, stored in a meeting metadata file, is synchronized with the telephone audio and the electronic information that was stored in the electronic meeting archive using a meeting start time and the meeting event times. The telephone audio may then be replayed responsive to and synchronized with the information obtained from the metadata.

### CROSS-REFERENCE TO RELATED APPLICATIONS

The present application is related to co-pending and commonly assigned U.S. patent application Ser. No. 10/854,762, Attorney Docket No. 47583/P048US/10316466 entitled, “SYSTEM AND METHOD FOR ARCHIVING COLLABORATIVE ELECTRONIC MEETINGS,” the disclosure of which is incorporated herein by reference.

### TECHNICAL FIELD

The present invention relates, in general, to electronic meeting space, and, more specifically, to integrating telephone audio into archives of electronic meetings.

### BACKGROUND OF THE INVENTION

The first Internet was a communications system funded and built by researchers for military use. This Internet, originally known as ARPANET, was embraced by the research and academic world as a mechanism for scientists to share and collaborate with other scientists. This collaborative network quickly evolved into the information superhighway of commerce and communication. The Internet explosion was due, in part, by the development of the World Wide Web (WWW) and Web browsers, which facilitated a more graphically-oriented, multimedia system that uses the infrastructure of the Internet to provide information in a graphical, visual, and interactive manner that appeals to a wider audience of consumers seeking instant gratification.

As the technology underlying transmission bandwidth has grown in conjunction with the accessibility to such increasing transmission bandwidth, a new paradigm for the old idea of Internet collaboration is emerging that takes advantage of the modern graphical, visual world. This new paradigm is also driven by the advance in real-time or time-sensitive data transmission technology. Videoconferencing, which has generally never been able to completely supplant teleconferencing as a viable means for communications, is slowly fading away in favor of Internet-driven technology, such as collaborative electronic meetings. Services, such as WEBEX COMMUNICATIONS, INC.'S, WEBEX™ electronic meeting or collaboration services offer the ability for users to connect, at least initially, across the Internet to share voice, video, and data in real time for meetings, presentations, training, or the like. While the WEBEX™ services are generally initiated over the Internet, once a collaborative meeting or session is established, the communications are transferred to a proprietary network.

Current electronic meeting space applications, including WEBEX™, allow recording of the actual meeting. Thus, audio, slide presentations, shared desktop sessions, chat, and other such information that takes place during the electronic meeting are recorded and may be viewed after the meeting is over. Many such online meeting software applications convert various file formats, such as MACROMEDIA, INC.'s MACROMEDIA FLASH™, MICROSOFT CORPORATION's POWERPOINT™, or the like into a single common format such as Small Web File (SWF) format, which is the native format for MACROMEDIA FLASH™, or WEBEX COMMUNICATION INC.'s UNIVERSAL COMMUNICATION FORMAT™ (UCF), thereby allowing the presentation and integration of different file format types. These applications typically record the playback of the meeting in this single, common format, much like a video camera would record some kind of visual presentation (i.e., the video camera would record a scene comprised of many different items into one movie).

While the advances in bandwidth capabilities supports the presentation of multimedia information over the Internet connections underlying the electronic meetings, voice communication is still largely conducted via teleconference. For example, in a typical electronic, online meeting, the parties meet in electronic meeting rooms where multimedia presentations may be played, screens and/or applications shared, whiteboard functionality used, and the like. However, voice communication is still typically made over the plain old telephone network (PSTN) or other standard telecommunications network. The voice communication that occurs over the PSTN is not recorded by the online meeting software applications. This is generally because there is no electronic communication between the PSTN and the electronic meeting system.

Incorporating voice communication over the same connection used for the electronic meeting is technically possible. However, including the voice communication over the network supporting the electronic meeting may cause poor quality audio during periods of high network traffic. While human perception may be able to process and perceive video or visual data that drops a few frames during transmission, it is much more difficult to process and perceive poor quality audio data or audio data that drops a few frames during transmission. Once the user experiences the diminished audio quality, he or she will be less likely to use the electronic meeting application again.

No facility currently exists that connects the two systems in such a fashion. In fact, existing electronic meeting applications have little or no integration with the telecommunications systems. In the most state of the art electronic systems, only basic teleconferencing controls are made accessible to the online meeting participant. In such systems, the meeting participants may start the conference, place someone on hold, or other such basic function. However, the audio from the voice communication on the teleconference is not included in the recordings or archiving of the electronic meeting. Selected teleconferencing systems may provide a recording or transcript of the teleconference to online meeting participants, but the recording is largely separate from the recording of the online meeting.

### BRIEF SUMMARY OF THE INVENTION

The present invention is directed to a system and method for integrating telephone audio into electronic meeting archives. A service gateway provides a communication link between the telephony server operating the teleconferencing functionality and the conferencing server operating the electronic meeting functionality. This gateway preferably translates the signaling information from the telephony server from the telephony-related format into a format compatible with the electronic meeting application. The telephony signaling may then be presented in the interface of the electronic meeting, such that full operation, control, and monitoring of a related teleconference may be directed from the electronic meeting interface.

The conferencing server monitors the teleconference signaling in addition to the electronic meeting and creates a metadata file that provides a detailed timeline of the electronic meeting. Timestamps are recorded in relation to meeting events, whether those events occur within the electronic meeting or whether they occur on the related teleconference. The teleconference recording may be obtained from the teleconference provider in any number of audio formats. When playing back the electronic meeting, or parts thereof, the conferencing server controls the playback of the teleconference audio using the detailed metadata file to provide synchronization of the meeting with the audio playback of the teleconference and the other electronic data that was presented in the electronic portion of the electronic meeting. Because the metadata file contains all of the details associated with the entire meeting, including the signals and information occurring on the teleconference, the conferencing server may playback the teleconference audio and supplement the playback with the detailed information from the metadata file, as to the identity of the speaker, the topics of discussion, which parties are attending the meeting via telephone only versus online, and other such detailed meeting information. Thus, the telephone audio from the teleconference portion of the electronic meeting is integrated with the electronic archives in an intelligent and meaningful way.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram illustrating electronic conferencing system 10 configured according to one embodiment of the present invention;

FIG. 2 is a block diagram illustrating electronic meeting 20 operating according to one embodiment of the present invention;

FIG. 3 is a timeline diagram illustrating the timing of telephone audio 30 of an electronic meeting conducted using one embodiment of the present invention;

FIG. 4 is a flowchart illustrating example steps executed to implement one embodiment of the present invention; and

FIG. 5 illustrates a computer system adapted to use embodiments of the present invention.

### DETAILED DESCRIPTION OF THE INVENTION

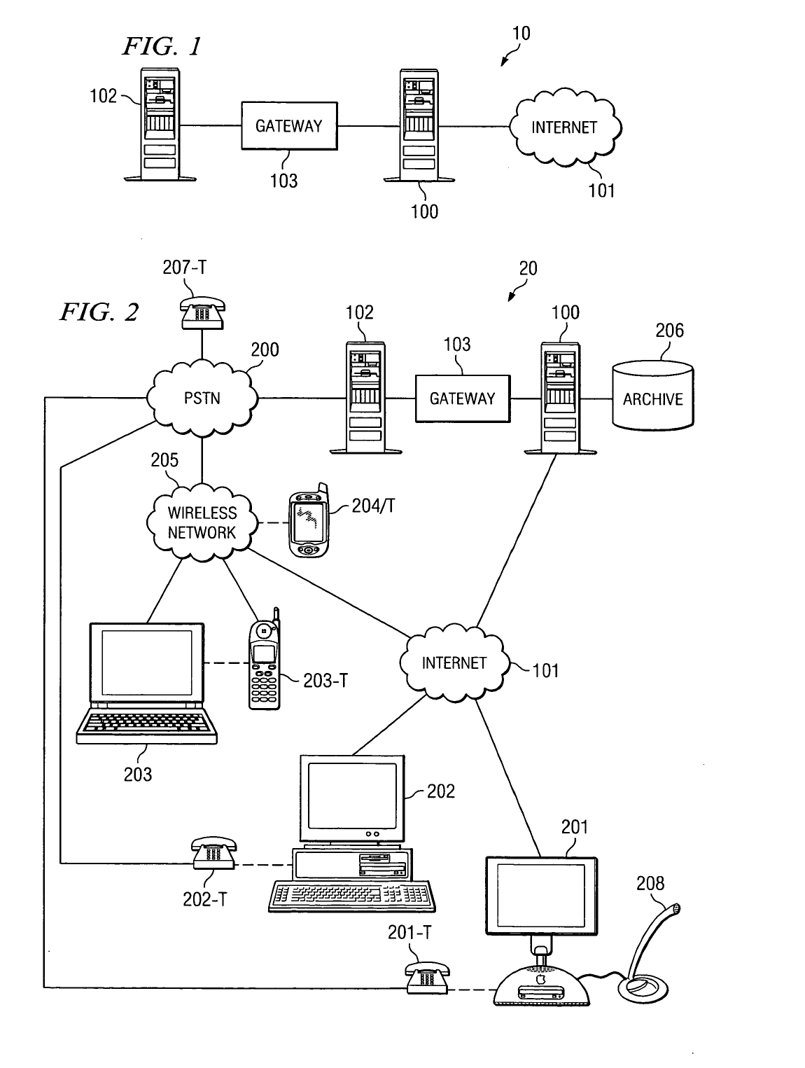

FIG. 1 is a block diagram illustrating electronic conferencing system 10 configured according to one embodiment of the present invention. Conferencing server 100 is an electronic, online conferencing server that manages collaborative, electronic meeting space. Conference server 100 is a real-time communication server that is capable of pushing messages out to client entities. One example of such a real-time communication server is MACROMEDIA INC.'s FLASH™ COMMUNICATION SERVER™ (FCS). Conferencing server 100 may operate an online, electronic meeting application, such as MACROMEDIA INC.'s BREEZE™. Meeting participants connect to the online meeting managed by conferencing server 100 over Internet 101. Each of the meeting participants that also participate in the teleconference related to the online meeting connect to telephony server 102, which manages the teleconference functionality. Telephony server 102 is connected to conferencing server 100 through gateway 103. Gateway 103 is specifically designed to translate the telephony-related format used by telephony server 102 into a format compatible with conferencing server 100. An example of a format used by telephony servers is the set of protocols defined by International Telecommunication Union's (ITU) H.323 protocol. Additionally, conferencing server 100 may communicate in any number of formats, such as extensible markup language (XML), and the like. Gateway 103 also provides a common application programming interface (API) to conferencing server 100 that allows command and control of telephony server 102 from conferencing server 100.

It should be noted that in various additional and/or alternative embodiments of the present invention, the functionality of gateway 103 may be divided between telephony server 102 and/or conferencing server 100, such that a separate gateway may not exist as a part of the inventive system. For example, conferencing server 100 may include an interface with telephony server 102 that communicates in the telephony-related format triggered by commands issued directly at conferencing server 100. Conversely, telephony server 102 may include an interface that communicates directly with conferencing server 100 in the format compatible with conferencing server 100. Similarly, each of conferencing server 100 and telephony server 102 may include parts of the functionality used to affect communication between the two servers.

FIG. 2 is a block diagram illustrating electronic meeting 20 operating according to one embodiment of the present invention. Meeting participants connect to the online portion of electronic meeting 20 using computers 201-203 and enhanced phone 204/T. Computers 201-203 connect to conferencing server 100 via Internet 101. Enhanced phone 204/T connects to conferencing server 100 via wireless network 205, which sends data signals to Internet 101. Meeting participants connect to the teleconference portion of electronic meeting 20 using telephones 201-T-203-T and enhanced telephone 204/T. Telephones 201-T and 202-T connect to telephony server 102 through PSTN 200, while telephone 203-T and enhanced telephone 204/T connect first to wireless network 205 which sends voice communication data to PSTN 200. Telephony server 102 manages the conferencing of each of the teleconference participants. Telephony server 102 and conferencing server 100 communicate with each other through gateway 103.

When electronic meeting 20 begins, conferencing server 100 begins creation of a meeting metafile that will be saved in archive 206 and telephony server 102 begins recording the telephone audio on the teleconference. The electronic meeting may be recorded onto archive 206 using various archiving means, including the archiving means described in commonly-assigned, co-pending U.S. patent application Ser. No. 10/854,762, entitled, “SYSTEM AND METHOD FOR ARCHIVING COLLABORATIVE ELECTRONIC MEETINGS,” the disclosure of which is incorporated herein. The meeting metafile begins with a timestamp identifying the beginning time of the meeting. As each user joins the meeting, identification information on the meeting participants is located or determined and associated with any visual representations within the meeting interface displayed to each of the meeting participants on their computer displays. This information is also added to the meeting metafile noting the time each participant joins the meeting both online and in the teleconference. Conferencing server 100 knows when each participating client joins the teleconference by receiving signals from telephony server 102. The signals transmitted from telephony server 102 are received by gateway 103 and translated into the conference-compatible format before being transmitted to conferencing server 100.

Telephony server 102 provides various signals as a part of its normal functionality. If a party places his or her phone on hold, mute, or other such different state, telephony server 102 would issue a signal designating such phone state. Through gateway 103, conferencing server 100 would receive the signals identifying the state that any of the telephone connections are in within the teleconference. Telephony server 102 also maintains call data signals such as Automated Number Identification (ANI) signals, which identify the telephone number of the calling party (i.e., caller ID), Dialed Number Identification Service (DNIS) signals, which identify the telephone number called by the calling party, and the like. Therefore, conferencing server 100 may also receive the telephone numbers of the conference participants on the teleconference. Using this caller ID information, conferencing server 100 may cross-reference existing databases or information to determine the identities of the conference participants.

Additionally, telephony server 102 is capable of detecting the line from which audio is being received. Therefore, by receiving signals identifying the current phone line speaking along with the caller ID information for that phone line, conferencing server 100 may determine which teleconference participant is the current speaker at any given time. This may be reflected visually by icons and/or animations specifying the currently speaking party on the visual interface of the online meeting on each of computers 201-203 and enhanced telephone 204/T. Each time this information is received by conferencing server 100, a notation is added to the meeting metafile identifying the time of each event along with the nature of the event.

Telephony server 102 may also control various call aspects of the teleconference participants. For example, telephony server 102 may control the volume of the telephone audio originating at any of telephones 201-T-203-T, enhanced telephone 204/T, and telephone 207-T. Callers may be muted completely, placed on hold, disconnected, connected, and the like. Because telephony server 102 is capable of controlling such functionality, conferencing server 100, through its connection to telephony server 102 via gateway 103, may also control the telephone audio for each of the teleconference meeting participants. Commands issued through the online meeting interface may be relayed through conferencing server 100, converted at gateway 103, and issued at telephony server 102 to affect some kind of control functionality. Therefore, the volume, or any other aspect of the teleconference audio, of each of the teleconference participants may be controlled.

Furthermore, because one of the functionalities that telephony server 102 is capable of performing is connecting callers, a meeting host may provide that conferencing server 100 call each of the participants in the electronic meeting, such that the participants would not have to call in to the teleconference. The accessible database of phone numbers and contact information may be accessed by the meeting host and/or conferencing server 100, or the meeting host may manually enter phone numbers to instruct telephony server 102, through gateway 103, to call out to each of telephones 201-T-203-T and 207-T, and enhanced telephone 204/T. Thus, the electronic meeting may be initiated by conferencing server 100, instead of relying on the meeting participants to join into the meeting on their own.

At the end of electronic meeting 20, conferencing server 100 obtains a recording of the telephone audio from telephony server 102 and stores it onto archive 206. Using the meeting metafile, the entirety of electronic meeting 20 may be reviewed or replayed in whole or in part. The online portion of electronic meeting 20, including the meeting metafile, has also been recorded onto archive 206. As a replay of electronic meeting is begun, the telephone audio file is replayed, synchronized by conferencing server 100 using the meeting metafile. Because the telephone audio file and the meeting metafile will be synchronized, the descriptive information about the content of the meeting will be matched up with the timing of the audio replay. Therefore, even though telephony server 102 is generally not able to record the audio of the teleconference including any additional information, such as identifying the various start times, stop times, hold statuses, currently speaking participant, or the like, the replay of electronic meeting 20 by conferencing server 100 may provide the detailed information on the entire meeting by using the metadata recorded in meeting metafile and synchronized with the audio in the telephone audio file.

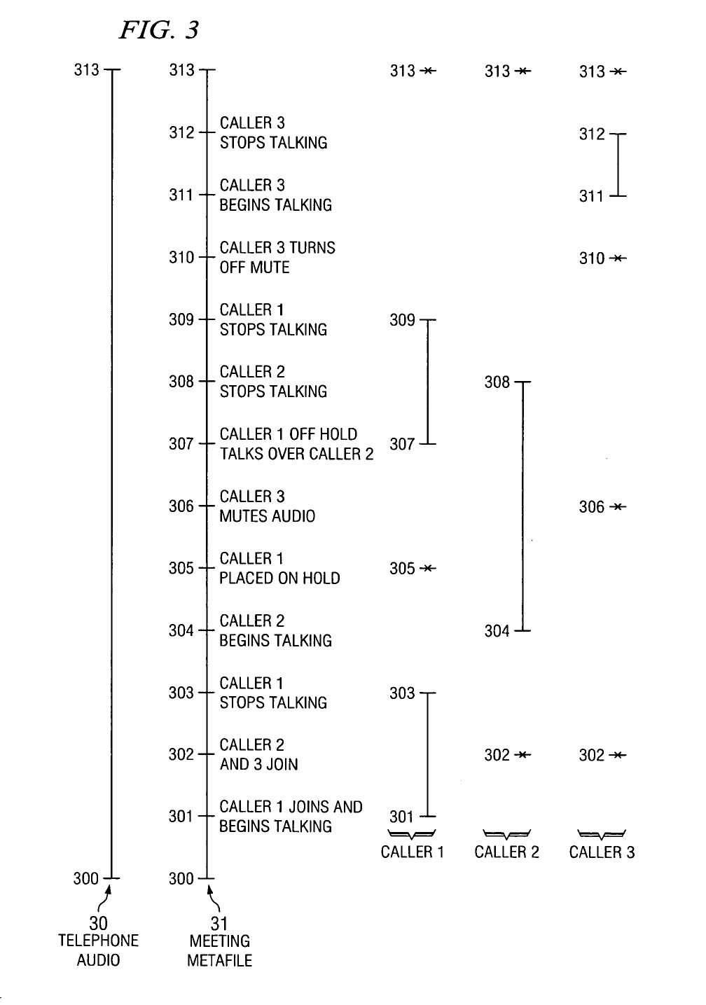

FIG. 3 is a timeline diagram illustrating the timing of telephone audio 30 of an electronic meeting conducted using one embodiment of the present invention. Telephone audio 30 is an audio file recorded by a telephony server that coordinates and/or manages the teleconference bridge of an electronic meeting. It may be recorded in various formats or compression algorithms, including, but not limited to, wave (WAV) format, various Moving Pictures Expert Group (MPEG) formats, Advanced Audio Coding (AAC) format, or the like. The conferencing server that manages the electronic conference obtains telephone audio 30 and stores it as a part of the electronic archive of the meeting. During the meeting, the conferencing server created meeting metafile 31 that includes various meta information detailing the events that occurred at the meeting. The meeting data includes data that is generated originally by the conferencing server and information obtained from other sources, such as the telephony server. For example, the telephony server may send phone number information about the party that is currently speaking on the teleconference. That phone number information may then be used by the conferencing server to cross-reference company employee databases to determine who that person is connected to the phone number. If a match is found, the conferencing server would generate a piece of metadata in meeting metafile 31 that the particular employee or meeting participant was speaking at that point in time. Additionally, the telephony server can provide status information for each of the participating callers. For instance, at time point 306, Caller3 places his or her phone on mute. The telephony server notes this change in status and sends an event message to the conferencing server which make a metadata notation in meeting metafile 31. Alternatively, a meeting host may select to place a caller on hold through the meeting interface. The conferencing server would issue that command to the telephony server through the service gateway and then generate a metadata notation of this action in meeting metafile 31.

Telephone audio file 30 is a single recording of the audio that occurred during the teleconference. It is bounded by start time 300 and end time 313. Meeting metafile 31 also includes notations of the various events that occur during the electronic meeting, including the same start and end times, start time 300 and end time 313. During a particular playback, meeting metafile 31 is synchronized with telephone audio file 30. Beginning at start time 300, the conferencing server may begin playback of the audio from telephone audio file 300. At time point 301, Caller1 joined the conference call and began talking. This is also represented in Caller1 timeline. Caller1 joins and begins talking at time point 301. Thus, during playback, the meeting interface reflects that Caller1 is speaking, while the audio being played from telephone audio file 30 will reflect the speech of Caller1 after time point 301.

At time point 302, Caller2 and Caller3 both join the teleconference. Caller1 stops talking at time point 303, while Caller2 begins talking at time point 304. The conferencing server uses meeting metafile 31 to index telephone audio file 30 for playback. For example, if a user desires to replay only the first half of the meeting, meeting metafile 31 will be used to play back the relevant parts of telephone audio file 30. During this playback, the meeting environment interface uses the metadata from meeting metafile 31 to provide relevant visual information to the user. The interface may visually indicate which meeting participant is speaking, when a participant joined the meeting, and the like, such as by providing a specific icon that represents a current speaker in a meeting participant window or pod. Therefore, the meeting interface uses the metadata of time points 300-309 to synchronize the playback of the audio from telephone audio file 30 with the electronic information recorded by the conferencing server to replay the first half of the meeting.

A user may also desire to search the general archive for discussions of a particular topic. For example, the user may desire to review all discussions of product sales. During the meeting, Caller2 discussed product sales between time points 304 and 308, and Caller3 discussed product sales between time points 311 and 312. In compiling the replay of the meeting excerpts, the archiving functionality would assemble the electronic archives, such as slides, animations, graphs, or the like that were presented visually on the electronic portion of the meeting that dealt with product sales and replay the teleconference audio from telephone audio 30 using the synchronizing data from meeting metafile 31. The archiving function would replay the audio between time points 304 and 308 and between 311 and 312 synchronized to the electronic events being displayed at the corresponding time points. Thus, meeting metafile 31 operates as a framework or index that is used by the system to control replay of telephone audio 30 in a manner that is synchronized to the replay of the electronic information presented in the electronic portion of the meeting.

It should be noted that in additional and/or alternative embodiments of the present invention, conferencing server 100 (FIG. 2) may automatically replay telephone audio file 30 (FIG. 3) using meeting metafile 31 (FIG. 3) and record new audio files that include the additional audio-related information from meeting metafile 31. Thus, the system of this embodiment would generate one or more audio files that are more-fully compatible with the archived information from the meeting. Instead of recording only a single audio file with all of the audio information thereon, the new files would be divided into separate threads or channels that correspond to the individual speakers, topics, or the like, as divided by the metadata within meeting metafile 31.

It should be further noted that in additional and/or alternative embodiments of the present invention, conferencing server 100 (FIG. 2) may include speech-to-text conversion capabilities, such that an electronic transcript of the teleconference audio may be generated by running the speech-to-text application on telephone audio file 30 (FIG. 3). In such embodiments, the converted text file may be used by the system to search for topics, words, or other content indicators indicating the topic of the conference audio. Such capabilities would allow users to search for topics of the telephone audio in addition to searching for topics of other visual information that is on display in the electronic portion of the meeting.

It should further be noted that additional and/or alternative embodiments of the present invention may include capability to merge and integrate non-telephone audio into the teleconference. Referring back to FIG. 2, instead of calling into the telephone conference using telephone 201-T, the user of computer 201 uses microphone 208 to provide his or her voice to the meeting. Because the audio for the voice being transmitted using microphone 208 would go directly to conferencing server 100 and not through telephony server 102, the other meeting participants would be able to hear the user's voice through their connecting computers, computers 201-203 and 204/T. However, because there is no computer connection to telephone 207-T, the user accessing the meeting with telephone 207-T would not be able to hear the voice of the user at computer 201. Similarly, because the user participating through telephone 207-T is a teleconference-only participant, the user at computer 201 will not be able to hear the user at telephone 207-T.

In order to accommodate this situation, the system of the described embodiment uses the functionality of gateway 103 to deliver computer-only audio into the teleconference through telephony server 102, and deliver teleconference audio to computer-only participants. When computer-only audio is present from a meeting participant, conferencing server 100 converts the audio format to a format compatible with telephone server 102. Conferencing server then streams the converted audio through gateway 103 to telephony server 102 to be added into the teleconference audio. Therefore, the meeting participants using telephones 201-T-203-T, 204/T, and 207-T may each hear the voice audio provided by the user at computer 201 speaking over microphone 208. Furthermore, telephony server 102 records this audio as a part of the teleconference recording. Thus, telephone audio file 30 (FIG. 3) would include the computer-only audio if the described embodiment were operated.

Similarly, when a computer-only participant is detected, the telephone audio from the teleconference may be streamed by telephony server 102 through gateway 103 to conferencing server 100 and then on to the audio capabilities of computer 201. The user at computer 201 would then be able to hear the voice audio of the teleconference even though he or she does not have an open telephone connection to the conference. The described embodiment may accomplish the streaming by converting into a computer/meeting interface-compatible audio format at telephony server 102, gateway 103, or even conferencing server 100. The described embodiment of the present invention is not intended to be limited to performing such conversion at any particular point in the electronic meeting infrastructure.

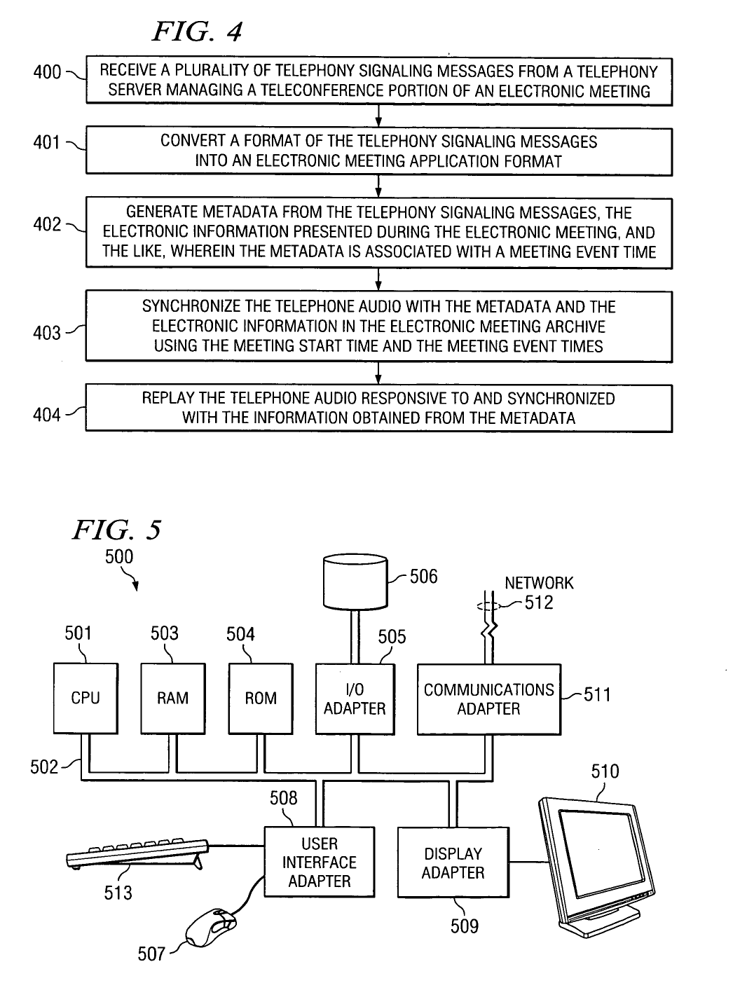

FIG. 4 is a flowchart illustrating example steps executed to implement one embodiment of the present invention. In step 400, a plurality of telephony signaling messages are received from a telephony server managing a teleconference portion of an electronic meeting. The telephony signaling messages are then converted, in step 401, into an electronic meeting application format. Metadata is generated, in step 402, from the telephony signaling messages, the electronic information presented during the electronic meeting, and the like, wherein the metadata is associated with a meeting event time. The telephone audio is synchronized, in step 403, with the metadata and the electronic information in the electronic meeting archive using the meeting start time and the meeting event times. In step 404, the telephone audio is replayed responsive to and synchronized with the information obtained from the metadata.

The program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, and the like. The computer data signal may include any signal that can propagate over a transmission medium such as electronic network channels, optical fibers, air, electromagnetic, RF links, and the like. The code segments may be downloaded via computer networks such as the Internet, Intranet, and the like.

FIG. 5 illustrates computer system 500 adapted to use embodiments of the present invention, e.g. storing and/or executing software associated with the embodiments. Central processing unit (CPU) 501 is coupled to system bus 502. The CPU 501 may be any general purpose CPU. However, embodiments of the present invention are not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Bus 502 is also coupled to input/output (I/O) controller card 505, communications adapter card 511, user interface card 508, and display card 509. The I/O adapter card 505 connects storage devices 506, such as one or more of a hard drive, a CD drive, a floppy disk drive, a tape drive, to computer system 500. The I/O adapter 505 is also connected to a printer (not shown), which would allow the system to print paper copies of information such as documents, photographs, articles, and the like. Note that the printer may be a printer (e.g., dot matrix, laser, and the like), a fax machine, scanner, or a copier machine. Communications card 511 is adapted to couple the computer system 500 to a network 512, which may be one or more of a telephone network, a local (LAN) and/or a wide-area (WAN) network, an Ethernet network, and/or the Internet network. User interface card 508 couples user input devices, such as keyboard 513, pointing device 507, and the like, to the computer system 500. The display card 509 is driven by CPU 501 to control the display on display device 510.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1-41. (canceled)

42. A computer implemented method comprising:
after an electronic meeting between at least two participants is completed, receiving, at a conferencing server from a telephony server separate from the conferencing server, a telephone audio recording recorded by the telephony server, the telephone audio recording comprises a voice portion of the completed electronic meeting, the voice portion transmitted as voice signals between telephone devices shared via the telephony server, the voice portion comprising a voice signal of each participant along with state information of the voice signal associated with each participant;
receiving at the conferencing server a request to replay one or more events that occurred during the electronic meeting;
responsive to the request, associating the one or more events with timing information of the completed electronic meeting, wherein:
i the timing information is indexed in a metadata file generated during the completed electronic meeting for a plurality of events that occurred during the completed electronic meeting,
ii the plurality of events are associated with an online portion of the electronic meeting recorded by the conferencing server, the online portion comprising electronic information transmitted between computer devices shared via the conferencing server that is visually presented during the electronic meeting and the telephone audio recording received from the telephony server; and
synchronizing playback of the voice portion in the telephone audio recording and a meeting archive of the online portion using the timing information.

43. The computer implemented method of claim 42 further comprising:
prior to when the electronic meeting is completed, translating the recorded voice signals from a telephony-related format into a conferencing format.

44. The computer implemented method of claim 42 further comprising, prior to when the electronic meeting is completed:
receiving an instruction from one of the participants during the electronic meeting to control a function of a connection on the telephone network;
converting the instruction into a telephony command executable by the telephone network to control the function; and
transmitting the telephony command via the telephone network for execution.

45. The computer implemented method of claim 42 further comprising and prior to when the electronic meeting is completed:
detecting, during the electronic meeting, one or more computer-only connections to the completed electronic meeting;
capturing voice-audio spoken into the one or more computer-only connections;
converting the captured voice-audio into a telephony-related audio format; and transmitting the converted voice-audio to the telephony server.

46. The computer implemented method of claim 42 further comprising and prior to when the electronic meeting is completed:
detecting by the conferencing server, during the electronic meeting, one or more computer-only connections to the completed electronic meeting;
receiving by the conferencing server a stream of voice data from the telephone network via the telephony server, wherein the stream represents voice audio of the telephone conference portion;
converting the stream into an audio format compatible with the conferencing server; and
transmitting the converted stream to the one or more computer-only connections.

47-57. (canceled)

58. A computer implemented method comprising:
initiating an electronic meeting between at least two participants, the electronic meeting conducted through separate transmissions of voice signals between telephone devices shared via a telephony server and electronic information between computer devices shared via a conferencing server, separate from the telephony server, the electronic meeting comprising:
a voice portion recorded by the telephony server, the voice portion comprising a voice signal of each participant along with state information of the voice signal associated with each participant, and
an online portion recorded by the conferencing server, the online portion comprising electronic information visually presented during the electronic meeting;
receiving by the conferencing server the voice portion of the electronic meeting;
generating a metadata file describing the timeline of the electronic meeting, the timeline defining an organization of the electronic meeting with separate portions of the electronic meeting each including at least one event based on the voice portion and one event based on the online portion;
storing the voice portion and the online portion of the electronic meeting along with the meta data file in the conferencing server;
responsive to a request received by the conferencing server for playback of the electronic meeting providing simultaneous playback of the voice portion and the online portion of the electronic meeting using the metadata file to provide synchronization of the voice portion and the online portion.

59. The computer implemented method of claim 58, further comprising:
issuing one or more commands, from the conferencing server to the telephony server to control the voice portion of the electronic meeting;
converting the one or more commands into a telephony-related format;
receiving by the telephony server the one or more commands; and
executing by the telephony server the one or more commands.

60. A conferencing server for an electronic meeting comprising:
a processor;
instructions stored in a non-transitory computer readable medium that, when executed by the processor, perform operations comprising:
initiate initiating the electronic meeting between at least two participants, the electronic meeting comprising a voice portion and an online portion conducted through separate transmissions of voice signals between telephone devices shared via a telephony server separate from the conferencing server and electronic information between computer devices shared via the conferencing server.
recording the online portion;
receiving the voice portion recorded by the telephony server, wherein the voice portion comprising a voice signal of each participant along with state information of the voice signal associated with each participant;
generating a metadata file describing a timeline of the electronic meeting, the timeline defining an organization of the electronic meeting with separate portions of the electronic meeting each including at least one event based on the voice portion and one event based on the online portion;
storing the voice portion and the online portion of the electronic meeting in the conferencing server; and
responsive to a request for playback of the electronic meeting, providing simultaneous playback of the voice portion and the online portion of the electronic meeting using the metadata file to provide synchronization of the voice portion and the online portion.

61. The conferencing server of claim 60, wherein the operations further comprise:
issuing one or more commands to the telephony server to control the voice portion of the electronic meeting.

62. The conferencing server of claim 61, wherein the operations further comprise:
detecting one or more computer-only connections to the electronic meeting;
capturing voice-audio spoken into the one or more computer-only connections;
converting the captured voice-audio into a telephony-related audio format; and
transmitting the converted voice-audio to the at least one telephony server.

63. The conferencing server of claim 61, wherein the operations further comprise:
detecting one or more computer-only connections to the electronic meeting;
capturing the voice signal of a participant in a telephony-related audio format;
converting the voice signal from the telephony-related audio format into an audio format compatible with the conferencing server; and
transmitting the converted signal to the one or more computer-only connections.

64. The method of claim 58 wherein the metadata file further comprises descriptive information of events occurring in the electronic meeting based on the state information, and wherein playback of the electronic meeting provides synchronization of the descriptive information along with the voice portion and the online portion.

65. The method of claim 64 wherein the descriptive information comprises an identity of a participant speaking

66. The method of claim 58 wherein the state information identifies hold status, start time, stop time, or a phone number corresponding to a voice signal of a participant.
